(19) United States
(12) Patent Application Publication
(10) Pub. No.: US 2003/0220979 A1
(43) Pub. Date: Nov. 27, 2003

(54) Virtual mobile phone - SMS box

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/444,997

(22) Filed: May 27, 2003

(30) Foreign Application Priority Data
May 24, 2002 (CA) 2,387,455

(51) Int. Cl. G06F 15/16; H04Q 7/20

(52) U.S. Cl. 709/206; 709/246; 455/466

(57) ABSTRACT

It present, there exist systems, which send emails, receive emails and replies, and store messages in boxes. There also exist systems, which send SMS messages to the network of one mobile phone operator, receive SMS messages and replies, and store SMS messages in boxes. However there exists no system so far, which would send SMS messages generally all over the world (to the GSM, CDMA and TDMA network), receive SMS messages and replies, and store SMS messages in boxes.

A communication system is suggested and described, which sends SMS messages to different networks and operators, receives SMS messages and replies, and stores messages in boxes. This system consists from www page generator, message receiver from computer, SMS message sender and receiver to/from mobile phones and the file storage area.

The said communication system enables the SMS messaging to be standard messaging, including sending, receiving and replaying, like email, instant messaging or ICQ. It also enables the SMS messaging to be combined with such messaging systems.

### FIELD

The present invention relates to a method of construction of a virtual mobile phone on a computer.

### BACKGROUND

It is usual to send emails from a computer, to receive them and to store them in message boxes either on a server or on the computer. However, there is at present no system for sending SMS messages from a computer to a mobile phone, to receive messages and to store them in message boxes either on the server or on the computer.

It is an object of the present invention to send SMS messages from a computer or server to a mobile phone, to receive messages and to store the messages in message boxes. A method of reply recognition may be used as well.

### SUMMARY OF THE INVENTION

According to the present invention there is provided a communication system for sending SMS messages from a computer through a server to a mobile phone, from a mobile phone to the computer and to recognize the messages and store them in associated boxes. The communication system includes the following:

(a) a www page generator on said server for generating www.pages;

(b) a message receiver on said server operative to receive a message from said www page; and

(c) a SMS message sender and receiver on said server operative to send SMS messages to a mobile phone and to receive SMS messages from a mobile phone and to store them into a file storage area;

The www.page generator, on receiving a request from the computer, generates a new www.page, and places messages from said file storage area to the new www.page and forwards the new www.paqe to the computer.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic drawing of the communication structure;

FIG. 2 is a schematic drawing of the www page for the present preferred embodiment; and

FIG. 3 is a schematic drawing of the parts of the Virtual Mobile Phone SMS Box communication system, used to send and receive messages.

### DETAILED DESCRIPTION WITH REFERENCE TO THE DRAWINGS

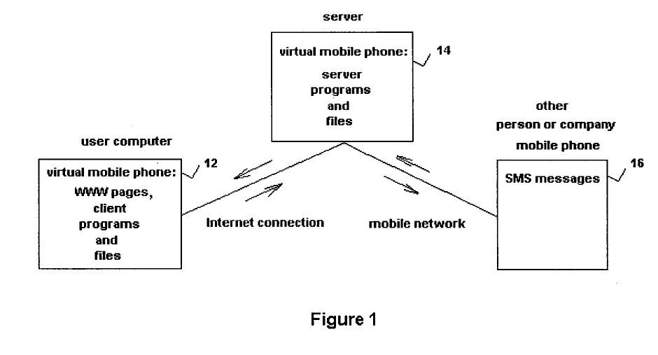

Referring to FIG. 1, SMS messages are sent from the user's computer 12 to the server 14 and then from the server 14 to the other person's mobile phone 16. Conversely, the same or another person may send SMS messages to the server 14, either as replies to the original sent SMS messages, or the messages may be mobile phone originated, starting with the recipient's identification. Alternatively, the user may have his/her own mobile phone number on the server 14.

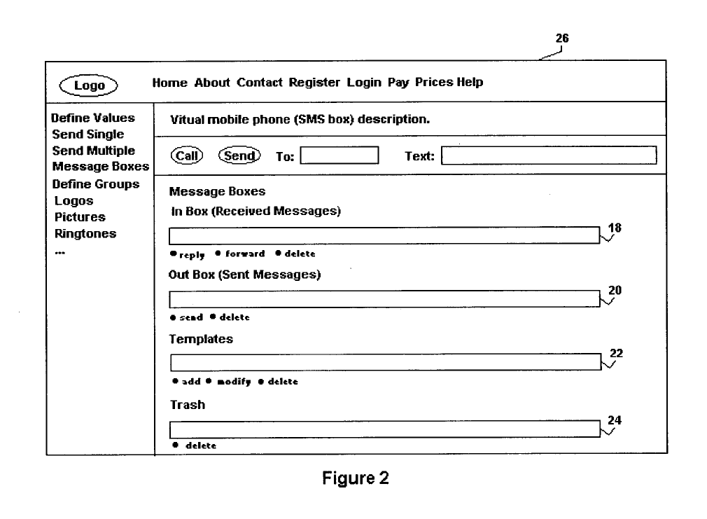

Sent and received SMS messages are stored in files either in the server 14 or in the user's computer 12. Referring to FIG. 2, a www.page 26 divides messages into four basic boxes, namely, an IN (Received) box 18, an OUT (Sent) box 20, a TEMPLATES box 22, and a TRASH box 24. The user can also define his/her own boxes, such as a Family box, a Friends box, a Business box, etc.

Each box is displayed on the display as a text array, a table, or as a list of messages. Each row in the box contains one message. The date, time, sender/receiver identification (from/to) and message text are written in one row. From/to means the sender or receiver identification (group and/or member name, communication identifier, email address, mobile phone number, etc.). Other data may be included in the message row, e.g. message number, subject, signature, etc. In addition the status of the message may be written (e.g., “received”, “seen”, “replied”, “sent”, “forwarded”, etc. . . . ).

With messages, one can send (forward) them, reply to them, define templates, delete them, and empty trash . . .

The present virtual mobile phone has a “Call” button, which enables the user to make phone calls from his/her computer which, in this case must be equipped with a microphone and speakers.

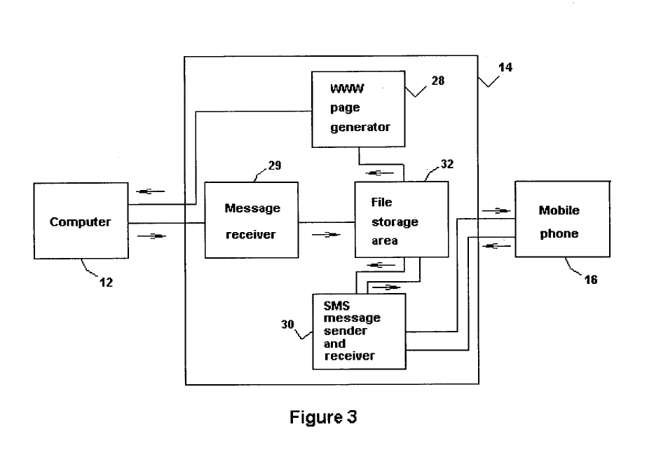

Referring to FIG. 3, the parts of modules stored on the server 14 include a www.page generator 28 which generates the www.pages of FIG. 2. A message receiver 29 receives messages from the www.page after they have been written by a user of computer 12 and stores them in a file storage area 32. An SMS message sender and receiver 30 takes a message from the file storage area 32, converts it into SMS message format and sends it to the mobile phone 16. The SMS message sender and receiver 30 also receives SMS messages from the mobile phone 16 and converts if from SMS format to file format and stores it in the file storage area 32. When the www.page generator 28 receives a request from the computer 12 it generates a www.page with updated messages and sends this www.page back to the computer 12.

The user can send SMS messages from the computer, receive messages sent to the computer and store them in boxes.

I claim:

1. A communication system for sending SMS messages from a computer through a server to a mobile phone, from a mobile phone to the computer and to recognize the messages and store them in associated boxes, comprising:
(a) a www page generator on said server for generating www.pages;
(b) a message receiver on said server operative to receive a message from a www page on said computer;
(c) file storage area on said server operative to store messages received from said computer and from the mobile phone;
(d) a SMS message sender and receiver on said server operative to send SMS messages to a mobile phone and to receive SMS messages from a mobile phone and to store them into said file storage area; wherein said www.page generator on request from said computer generates a new www.page, and places messages from said file storage area to said new www.page and forwards said new www.page to the computer.
